(19) United States
(12) Patent Application Publication
(10) Pub. No.: US 2020/0346121 A1
(43) Pub. Date: Nov. 5, 2020

(54) CREATION, CURATION, AND SHARING OF PLAYLISTS OF GAME MOMENTS

(71) Applicant: Microsoft Technology Licensing, LLC, Redmond, WA (US)

(72) Inventors: Jason Doyle BEAUMONT, Seattle, WA (US); Nicholas Jie FANG, Redmond, WA (US)

(21) Appl. No.: 16/401,048

(22) Filed: May 1, 2019

(51) Int. Cl. A63F 13/86; A63F 13/49; A63F 13/355; A63F 13/33

(52) U.S. Cl. CPC A63F 13/86; A63F 13/33; A63F 13/355; A63F 13/49

(57) ABSTRACT

Methods, systems, and computer program products enable sharing of in-game moments between users in the form of game states saved from video game play. A saved game state of a particular video game may be downloaded from a saved game repository to a gaming device individually or based on being included in a playlist. The video game is loaded with the downloaded game state at the gaming device. The video game is played based on the loaded game state, enabling game play beginning at a gameplay point defined by the loaded game state. A save function for the video game may be prevented while executing on the loaded game state. The video game executing on the loaded game state is terminated before game end. If a playlist is being played through, a next saved game state listed in the playlist may be downloaded and played on the gaming device.

### BACKGROUND

Video games (also referred to herein as “video game applications”) are games embodied in software that are played/interacted with by users (also known as “players” or “garners”) on electronic devices that execute the software. Examples of electronic devices capable of running video games include smart phones, tablets, laptops, personal computers (PCs), dedicated handheld units (e.g., a Nintendo 3DS®), or video game consoles (e.g., a Microsoft Xbox®, a Sony PlayStation 4®, a Nintendo Wii™, etc.). Such electronic devices may be referred to as “gaming devices.” Typically, a gaming device includes software that enables the execution of video games thereon. This software may be referred to as the “game platform.”

Traditionally, video games were purchased in the form of a cartridge, disk, or other physical storage medium that stored the video game. To play a video game, the storage medium storing the video game was inserted into the gaming device, the video game was loaded from the storage medium into memory of the gaming device, and the loaded video game was executed. Now, video games may be downloaded from network-based servers to devices for play. Even more recently, video games may be streamed. Game streaming is a technique of transmitting video game data from a first device (the “originating” or “source” device) running the video game application to a second device (the “game play” or “client” device”) to enable the user to play the video game using the second user device. During game play, input data associated with the input controls is transmitted from the second device back to the first device for the video game application to use in generating the video game data.

Video games are typically played in a linear fashion by each user. The user starts at the video game beginning, their in-game progress is saved as they play, and a game conclusion is ultimately reached. This journey is largely individual—other users do not participate in it. Any interesting in-game moments that occur are generally lost as far as other users are concerned, or are captured in videos that may be viewed by others, such as via YouTube™ owned by Google LLC, or Twitch® owned by Twitch Interactive (a subsidiary of Amazon.com, Inc.).

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Methods, systems, and computer program products are provided for the sharing of in-game moments between users in the form of individual shares of in-game moments, as well as the sharing of in-game moments in groups, such as in playlists.

In an aspect, saved game states defining in-game moments for video games are contributed to a saved game repository by users, such as gamers and/or game developers. A saved game state of a particular video game may be downloaded from the saved game repository to a gaming device. The video game is loaded with the downloaded game state at the gaming device. The video game is played based on the loaded game state, enabling game play beginning at a gameplay point defined by the loaded game state. In this manner, the gameplay point is enabled to be shared by the user that contributed the game state to the respository with a user at the gaming device.

Optionally, a save function of the video game may be prevented at the gaming device to disable saving in-game progress proceeding from the loaded game state. Furthermore, execution of the video game may be terminated before game end according to predetermined criteria. This disables unconstrained play of the video game that might be otherwise possible by loading the saved game state.

The saved game state may have been included in a saved game playlist at the repository. The playlist may be created and curated by one or more users, including one or more gamers, game developers, the game platform holder, the game publisher, and further entities. The playlist may identify multiple of games states of one or more video games. The user at the gaming device may select the playlist. The selected playlist is downloaded from the saved game repository to the gaming device in response to the selection. The saved game state may be selected for play from the downloaded playlist by the user, automatically by the gaming device, or in another manner.

After the play of the video game based on the saved game state concludes, a next game state may be downloaded from the repository that is next identified in the downloaded playlist. This downloaded game state may be associated with the same video game as the prior one, or a different video game. The appropriate video game is loaded with this downloaded game state, and is executed thereupon to enable game play at a corresponding gameplay point by the user. Any number of further saved game states of the playlist may be downloaded from the repository and played in sequence by the user at the gaming device.

If not already installed on the gaming device, the video game corresponding to a saved game state selected for download and play may need to be downloaded and installed on the gaming device, either temporarily (e.g., long enough to play the saved game state), or permanently (the user may need to purchase the game to use it other than playing through a saved game state). The video game may be downloaded in its entirety, or just a portion of the video game needed to support game play from the saved game state may be downloaded. In a game streaming case, the video game may be streamed from a source device to the gaming device. As such, a streaming client that supports streaming of the video game to the gaming device may be installed at the streaming client if not already present, and the streaming of the video game may commence at the gameplay point defined by the saved game state.

Further features and advantages of embodiments, as well as the structure and operation of various embodiments, are described in detail below with reference to the accompanying drawings. It is noted that the methods and systems are not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments of the present application and, together with the description, further serve to explain the principles of the embodiments and to enable a person skilled in the pertinent art to make and use the embodiments.

FIG. 1 shows a block diagram of a system for sharing saved video game states, according to an example embodiment.

FIG. 2 shows a block diagram of an example embodiment of the system of FIG. 1.

FIG. 3 shows a flowchart of a process for creating a playlist for shared video game states, according to an example embodiment.

FIG. 4 shows a block diagram of a display screen providing a user interface for configuring a playlist of shared video game states, according to an example embodiment.

FIG. 5 shows a block diagram of a display screen providing a user interface for creating playlists and for selecting playlists for modification, according to an example embodiment.

FIG. 6 shows a flowchart of a process for selecting a shared video game state for gameplay from a selected playlist, according to an example embodiment.

FIG. 7 shows a flowchart of a process in a user device for playing shared saved video game states, according to an example embodiment.

FIG. 8 shows a flowchart of a process for playing a video game on game states of a playlist, according to an example embodiment.

FIG. 9 shows a flowchart of a process in a server for enabling play of shared saved video game states at a user device, according to an example embodiment.

FIG. 10 shows a flowchart of a process in a server for suppressing game functions of a video game playing at a user device from a shared saved video game state, according to an example embodiment

FIG. 11 is a block diagram of an example processor-based computer system that may be used to implement various embodiments.

The features and advantages of the embodiments described herein will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The present specification and accompanying drawings disclose one or more embodiments that incorporate the features of the disclosed embodiments. The scope of the embodiments is not limited only to the aspects disclosed herein. The disclosed embodiments merely exemplify the intended scope, and modified versions of the disclosed embodiments are also encompassed. Embodiments are defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Furthermore, it should be understood that spatial descriptions (e.g., “above,” “below,” “up,” “left,” “right,” “down,” “top,” “bottom,” “vertical,” “horizontal,” etc.) used herein are for purposes of illustration only, and that practical implementations of the structures described herein can be spatially arranged in any orientation or manner.

In the discussion, unless otherwise stated, adjectives such as “substantially” and “about” modifying a condition or relationship characteristic of a feature or features of an embodiment of the disclosure, are understood to mean that the condition or characteristic is defined to within tolerances that are acceptable for operation of the embodiment for an application for which it is intended.

Numerous exemplary embodiments are described as follows. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### II. Example Embodiments

Video games (also referred to herein as “video game applications”) are games embodied in software that are played/interacted with by users (also known as “players” or “garners”) on electronic devices that execute the software. Examples of electronic devices capable of running video games include smart phones, tablets, laptops, personal computers (PCs), dedicated handheld units (e.g., a Nintendo 3DS®), or video game consoles (e.g., a Microsoft Xbox®, a Sony PlayStation 4®, a Nintendo Wii™, etc.). Such electronic devices may be referred to as “gaming devices.” Typically, a gaming device includes software that enables the execution of video games thereon. This software may be referred to as the “game platform.”

Video games are typically played in a linear fashion by each user. They start game play at the beginning, their in-game progress is saved as they play, and a game conclusion is ultimately reached. This journey is largely individual—other users do not typically participate in it. If there is an in-game moment that is interesting for some reason, and the user wants to share it with others, there are severe limits on how this can be done. Some video games in the PC space have local save files for saved games. If there are no restrictions on how those save files are stored or transmitted, those saved games can be shared with other devices by manually copying and pasting the save files to those devices. Alternatively, a video game can be written specifically to allow sharing of saved game state. A saved game state is a set of data that may be stored, and that defines a point in game play from which game play can be continued by the loading of that data. No current video game platforms, however, innately allow for the sharing of saved game states that is free to games and applies across different video games. As such, to reach an in-game moment of interest in a video game, a new user typically has to play their way though the video game until that in-game moment is reached. In some cases, attempting to replay a video game to reach a particular in-game moment is not even possible if unique and/or random events are involved in reaching the scenario involved in that in-game moment.

Furthermore, gaming devices games generally treat saved games as if they were locally owned and generated. For game platforms and ecosystems that have features that are based on individual progress (e.g., high scores that may appear on “leaderboards” showing the highest scores and the players who earned them, or “achievements” that are in-game awards for reaching certain in-game milestones), the sharing of video game states can be problematic for the platform. This is because users that receive and play from shared game states may obtain achievements or game scores they could not achieve on their own, or achieve as soon as a shared game state enables. Such behaviors might be interpreted as cheating (e.g., using a copied save file to earn an achievement that otherwise would be difficult to attain).

Finally, because the possible ways of sharing in-game moments in the form of saved game states mentioned above work on a game-by-game basis, there is no way to curate a collection of them. This limits the ability to build a robust system for sharing game moments across a collection of video games. There is no way to know which games support such sharing, and how to incorporate them into such a saved game sharing system.

Embodiments described herein overcome these problems. In embodiments, a game sharing system is provided by which users are able to share interesting gameplay moments from the video games they are playing. Embodiments enable other users to pick up and try those gameplay moment for themselves in a manner that does not impact their progress on ecosystem features such as leaderboards and achievements. Furthermore, embodiments do not require specific work on the part of game developers to enable.

In an embodiment, playlists of such shared gameplay moments may be created and curated. Such a playlist may include any number of shared gameplay moments (e.g., spectacular vehicle crashes, boss battles, explosions, monster kills, etc.), which may span any number of video game titles and/or franchises. Playlists may be published by anyone, including popular video game streamers (users who play video games and stream their played video games for other users to view), who may publish playlists across their favorite games. Users may be enabled to subscribe to playlists (which may be modified over time), and may recommend their own or other playlists to their friends. These features have the benefit of substantially improving user engagement with video game titles, which may help sell video games as well as encourage users to take part in subscription services like Xbox® Game Pass provided by Microsoft Corporation. Furthermore, such features enable deeper engagement between users and video game developers with other users and with their followers.

In an embodiment, a new or existing video game platform may be enhanced to enable video game sharing to centralized lists, which may then be shared with other users who are granted access (e.g., either directly or through a curated user interface of the platform). A shared saved game may be presented for download in a same or similar manner to a normal saved game. However, in an embodiment, the game platform downloading the shared saved game may be configured to detect that the saved game is a shared saved game, and in response, in some configurations, disable the ability for users to perform functions such as normal game saves of the shared saved game when played. Furthermore, the game platform may be configured to stop logging in-game progress for the saved game to leaderboards and achievements. As such, game sharing is enabled without adversely affecting the health or fairness of the overall ecosystem.

A shared saved game (in the form of a saved game state) may define a gameplay start point for experiencing the gameplay moment. In an embodiment, the shared saved game may enable the user who shared the saved game to dictate a gameplay moment when that shared game ends, and/or the game platform may be configured to end gameplay of the shared game based on one or more triggers. Such triggers may be configured manually (e.g., a predetermined amount of time, or a predetermined acceptable number of play attempts for a particular shared saved game, etc.) or via maching learning (ML) techniques for detection of certain game conditions to trigger game end.

For example, in an embodiment, game data generated by a video game may include game video in the form of a video stream of video frames. During game play, game-related data (e.g., game video frames, game audio data, streams of input events, hardware usage metrics during video game play, further metadata generated during video game play such as log file contents, API (application programming interface) accesses, etc.) may be analyzed to identify one or more game-related features that correspond to the current game scenario, which may correspond to an end game condition. Once identified, the gaming device may end play of the video game that began based on a loaded saved game state.

A trained ML model for detecting an end game condition may be generated in various ways. For instance, to generate such a model, the video game may be executed in a machine learning (ML) application, such as TensorFlow™, to generate training game data that includes a training video stream. Training indications corresponding to the video game may be inputted into the ML application during training game play. In one embodiment, the training indications are inputted manually (e.g., by a game developer). Alternatively, the training indications may be provided automatically, such as by a computer. The trained machine learning model is generated based on the training indications and the generated training game data, and may be used during game play to detect end game conditions.

Note that embodiments are often described herein in an online context (e.g., where playlists and shared game states are downloaded from a network-based server), although embodiments also apply to an offline context. In such an offline context, playlists and their shared game states may be downloaded to local storage of the gaming device, and may be accessed therefrom. For instance, a playlist may be selected by the user from a set of playlists in the local storage, and the shared game states that are listed in the playlist may be sequentially accessed from the local storage to be loaded into the video game application and played by the user. Accordingly, embodiments described herein for the online context may be adapted for the offline context, as would be understood by persons skilled in the relevant art(s) from the teachings herein.

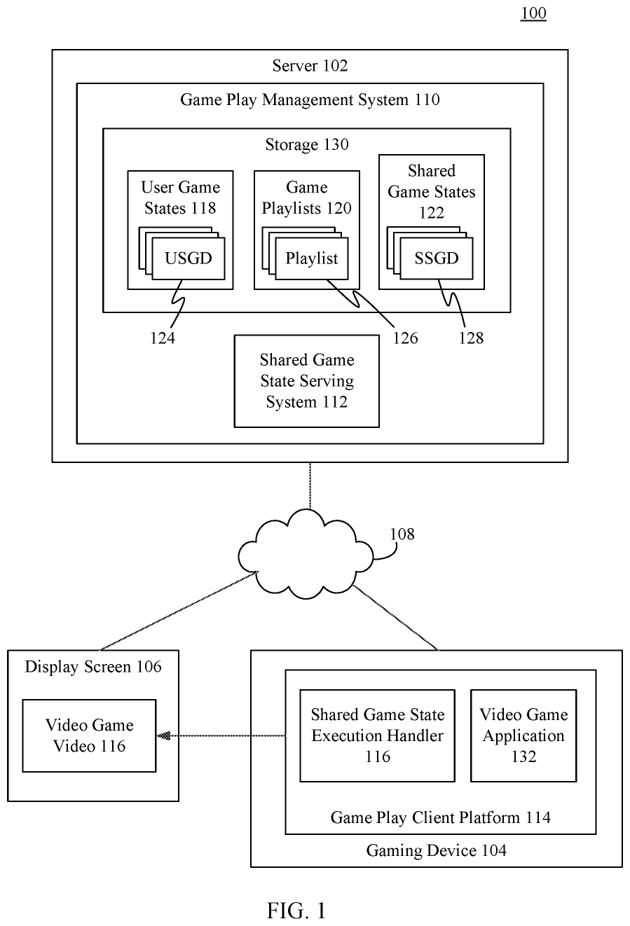

Embodiments for enabling users to share and play saved video game states may be implemented in various ways. For instance, FIG. 1 shows a block diagram of a gaming system 100 configured for the sharing and playing of saved video game states, according to an example embodiment. As shown in FIG. 1, system 100 includes a server 102, a gaming device 104, and a display screen 106. Server 102 and gaming device 104 are communicatively coupled by a network 108. Server 102 includes a game play management system 110, which includes storage 130 and a shared game state serving system 112. Gaming device 104 includes a game play client platform 114, which includes a shared game state execution handler 116. System 100 is described in further detail as follows.

Server 102 may be a server, server set, or other computing device(s) capable of managing the network-based portion of a gaming platform, and in some embodiments may be capable streaming video games. Server 102 may include any number of computing devices, an in an embodiment may be incorporated in a server set such as a “cloud-computing” server system. Storage 130 may include one or more of any type of physical storage mechanism, including a magnetic disc (e.g., in a hard disk drive), an optical disc (e.g., in an optical disk drive), a magnetic tape (e.g., in a tape drive), a memory device such as a RAM (random access memory) device, a ROM (read only memory) device, etc., and/or any other suitable type of storage medium.

Gaming device 104 may be any type of computing device, mobile or stationary. For instance, gaming device 104 may be a mobile computing device, such as a Microsoft® Surface® device, a personal digital assistant (PDA), a laptop computer, a notebook computer, a tablet computer such as an Apple iPad™, a netbook, a mobile phone (e.g., a cell phone, a smart phone such as an Apple iPhone, a phone implementing the Google® Android™ operating system, etc.), a wearable computing device (e.g., a head-mounted device including smart glasses such as Google® Glass™, a virtual headset such as Oculus Rift® by Oculus VR, LLC or HoloLens® by Microsoft Corporation, etc.), a stationary computing device such as a desktop computer or PC (personal computer), a gaming console/system (e.g., Microsoft Xbox®, Sony PlayStation®, Nintendo Wii® or Switch®, etc.), etc. Display screen 106 may be any type of display screen of a display, including a plasma display screen, a LCD (liquid crystal display) display screen, an LED (light emitting diode) display screen, a projector screen, a headset display (single or one per eye), etc. Display screen 106 may be incorporated in gaming device 104 (e.g., a screen of a tablet computer, a smart phone, a handheld gaming device) or may be separate from gaming device 104 (e.g., a desktop monitor, a projector screen).

Network 108 may be any network, wireless and/or wired, which may include one or more of a local area network (LAN) such as a wireless LAN (WLAN) or “Wi-Fi”), a wide area network (WAN), such as the Internet, a network cable, etc.

Video game application 132 is a video game program (e.g., implemented in program code executed by one or more processors of gaming device 104). Video game application 132 may be any type of video game, including a causal game, a serious game, an educational game, shooter game, driving game, etc. During execution, video game application 132 generates video game video 116 displayed by display screen 106. Video game video 116 is video representative of the video game during play, and is presented to the user at display screen 106. Video game application 132 may also receive user input data from one or more user interface devices used by the user, such as a game controller, a touch screen, a keyboard, etc. The user input data indicates the actions taken by the user in playing the video game (e.g., pushing a button, moving a stick to the right, etc.). The user input data is processed by video game application 134 to determine how the video game proceeds, and thus is used in the generation of video game video 116 presented to the user.

Game play management system 110 at server 102 and game play client platform 114 at gaming device 104 cooperate to enable video games, such as video game application 132, to be played in a networked manner, which enables enhanced features for users and for the video games themselves. Such features may include the maintaining of user gaming profiles, user in-game achievements, leaderboards, user friends lists, online saving of in-game progress (e.g., game state data), video game streaming, purchases of video games from an online store, downloading of video games, etc. Game play management system 110 manages the gaming platform at the server/network-side, including managing the gaming platform for any number of users (e.g., numbers of users in the hundreds, thousands, millions, etc.) and multiple video games. For instance, game play management system 110 may manage the online storing of the user gaming profiles, user in-game achievements, leaderboards, the downloading and/or streaming of video games, the interactions of multiple users playing a same video game together from separate gaming devices, etc. Game play client platform 114 manages the gaming platform at the user/user device-side. For instance, game play client platform 114 may manage the play of video games at gaming device 104 by the user of gaming device 104, including receiving the download of a video game, receiving streamed video game data, transmitting game play data to and receiving game play data from game play management system 110. Game play client platform 114 may also provide a user interface for users to configure their user profile, for initiating the download of video games, the online purchase of video games, etc. Still further, game play client platform 114 may manage the collection of information from played video games (e.g., user scores, achievements) and the transmitting of this information (including saved game files) to game play management system 110 over network 108.

For instance, a user at gaming device 104 executing video game application 132 may decide to save their in-game progress, or video game application 132 may save the user's in-game progress automatically. Such a save may generate a user game state encapsulating the user's in-game progress. The user game state may be generated as one or more files or other form of saved game state data, and that is transmitted by game play client platform 114 from gaming device 104, over network 108, to game play management system 110 at server 102. The user game state may be saved as user save game data (USGD) 124 in user game states 118 in storage 130. User game states 118 may include any number of instances of user save game data for the user, and for further users, for video game application 132 and/or for any number of further video games.

Shared game state serving system 112 is configured to interact with shared game state execution handler 116 to manage the downloading to gaming device 104 of game states shared by users. The shared game states enable other users to play the in-game moments that follow from those game states.

In particular, as further described elsewhere herein, a user may elect to share one of their user game states 118 with other users. In such case, user saved game data 124 for the user game state selected to be shared (or a link thereto) may be copied to shared game states 122 in storage 130 as shared saved game data (SSGD) 128. Shared game states 122 includes game states, such as SSGD 128, embodied as saved game data, that have been designated for sharing with other users. Such sharing of a particular shared game state may be designated as public (to all users) or designated with limits such as sharing only with friends, designated users, subscribers, etc.). It is noted that SSGD 128 does not need to include a full memory state of the played video game (e.g., does not include the video game files that were loaded into memory to enable gameplay).

Still further, as described in more detail elsewhere herein, a user may elect to create a playlist that lists one or more of the saved game states. As shown in FIG. 1, a set of game playlists 120 may be stored in storage 130 that includes one or more playlists 126. A playlist 126 identifies a list of saved game states of saved game states 122 for sequential play at a gaming device that selects playlist 126, such as gaming device 104.

Shared game state execution handler 116 communicates with shared game state serving system 112 to access the shared game state-related information managed by shared game state serving system 112, including the downloading of individual shared game states of shared game states 122, as well as playlists of game playlists 130, for play by game play client playform 114. In the case of a selected playlist, such as playlist 126, shared game state execution handler 116 downloads the shared games states identified in playlist 126 in a sequential manner to be played by a user at gaming device 104.

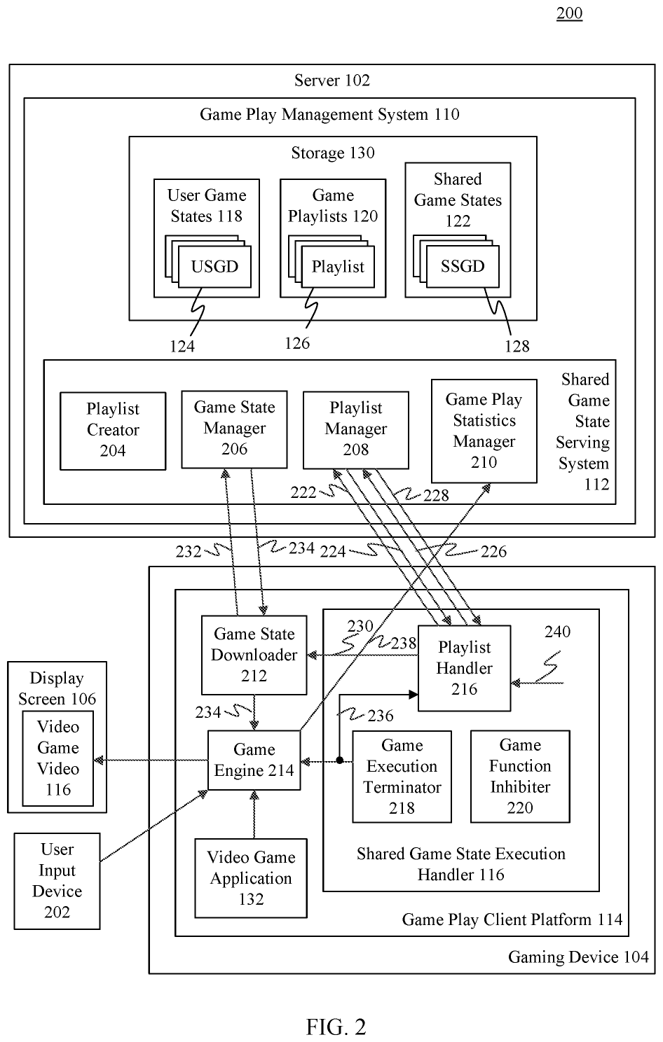

In embodiments, system 100 may operate in various ways to perform its functions. For example, FIG. 2 shows a block diagram of a gaming system 200, which is an example of gaming system of FIG. 1. As shown in FIG. 1, gaming system 200 includes server 102, gaming device 104, display screen 106, and a user input device 202. User input device 202 is optionally present, and may be any suitable UI device for a user of gaming device 104 to interact with gaming system 200, including a game controller, a touch screen, a keyboard, etc. A network that couples server 102 and gaming device 104 is not shown in FIG. 2 for ease of illustration. Server 102 includes game play management system 110, which includes storage 130 and shared game state serving system 112. Shared game state serving system 112 includes a playlist creator 204, a game state manager 206, a playlist manager 208, and a game play statistics manager 210. Gaming device 104 includes game play client platform 114, which includes shared game state execution handler 116, a game state downloader 212, and a game engine 214. Shared game state execution handler 116 includes playlist handler 216, game execution terminator 218, and game function inhibiter 220. System 200 is described in further detail as follows.

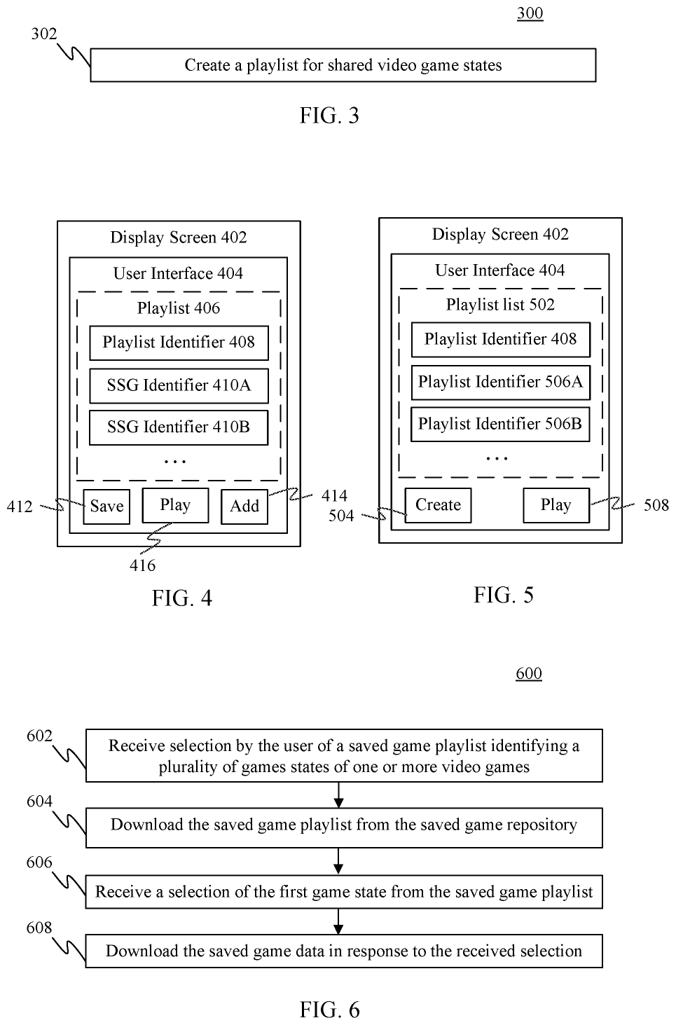

In particular, FIGS. 3 and 6-11 show various flowcharts related to processes for managing the sharing of video game states, according to example embodiments. These flowcharts may be performed by gaming systems 100 and 200. For the purposes of illustration, these flowcharts are described as follows with reference to system 200 of FIG. 2.

A. Embodiments for Creation and Curation of Playlists

For example, FIG. 3 shows a flowchart 300 of a process for creating a playlist for shared video game states, according to an example embodiment. Flowchart 300 begins with step 302. In step 302, a playlist is created for shared video game states. In an embodiment, playlist creator 204 of FIG. 2 may enable a user to create and curate a playlist, such as playlist 126. For instance, playlist creator 204 is configured to enable a user interface to be generated that enables a user (e.g., a gamer, a game developer, a game streamer, etc.) to select game states of shared games states 122 to include in playlist 126, to arrange an order of the game states for play, to remove game states from playlist 126, and/or to otherwise create and/or curate playlist 126. In an embodiment, playlist creator 204 may provide an interface, such an an API (application programming interface), for access by playlist handler 216 or other entity to retrieve information to use to generate the user interface for interaction by a user to configure a playlist.

For example, FIG. 4 shows a block diagram of a display screen 402 providing a user interface 404 for configuring a playlist 406 of shared video game states, according to an example embodiment. Display screen 402 may be the display screen associated with a gaming device, such as display screen 106 (FIGS. 1 and 2) associated with gaming device 104, or may be associated with a different user device. User interface (UI) 404 may be a graphical user interface (GUI) generated by playlist handler 216 (or by another entity at a user device) displaying information provided by playlist creator 204 for interaction therewith. UI 404 may include any number and types of UI controls, including buttons, pull down menus, check boxes, text boxes, etc. Example controls are shown as first control 412 (labeled “Save”), a second control 414 (labeled “Add”), and a third control 416 (labeled “Play”). A user may interact with UI 404 to configure a playlist, such as a playlist 406. For instance, as shown in FIG. the user may configure a playlist identifier 408 for playlist 406 which is a name or other identifier for playlist 406 to be identified and selectable in game playlists 120 of FIG. 2. Any number of saved game states may be selected for inclusion in playlist 406. For example, FIG. 4 shows first and second SSG (shared saved game) identifiers 410A and 410B having been selected for inclusion in playlist 406. SSG identifiers 410A and 410B are names or other identifiers (given by a user or generated automatically) for particular saved game states stored in shared game states 122 of FIG. 2.

In the example of FIG. 4, second control 414 may be selected (e.g., pressed, clicked upon) to show a list of shared game states in shared game states 122 that may be selected and added to playlist 406. Shared games states may be removed from playlist 406, such as by selecting a shared game state and pressing a “delete” key, pulling a trigger on a game controller of user input device 202, or performing other action. Shared game states may be reordered in playlist 406 by drag-and-drop or other action. First control 412 may be selected to save and close playlist 406 in game playlists 120.

FIG. 5 shows a block diagram of display screen 402 providing user interface 404 for creating playlists and for selecting playlists for modification, according to an example embodiment. UI 404 in FIG. 5 may be generated by by playlist handler 216 (or by another entity at a user device) displaying information provided by playlist creator 204 for interaction therewith. UI 404 may have any number and types of UI controls mentioned elsewhere herein or otherwise known. As shown in FIG. 5, user interface 404 displays a playlist list 502, a fourth control 504 (labeled “Create”), and a fifth control 508 (labeled “Play”). As shown in FIG. 5, playlist list 502 identifies a set of playlists included in game playlists 120 (FIG. 2), with each playlist identified by a corresponding identifier. For instance, three playlists are identified in playlist list 502 by playlist identifiers 408, 506A, and 506B. A user may interact with UI 404 to interact with any of the playlists of playlist list 502. For instance, the user may select an existing playlist in playlist list 502 to view its contents, or may remove a playlist, such as by selecting a listed playlist and pressing a “delete” key, pulling a trigger on a game controller of user input device 202, or performing other action. Furthermore, the user may select third control 504 to create a new playlist. Selecting third control 504 may enable a playlist to be created as described above with respect to FIGS. 3 and 4 (e.g., invoking user interface 404 of FIG. 4).

B. Embodiments for Saved Game State Selection at User Devices

When a user desires to play a video game based on a shared game state, the user may select the shared game state for play in various ways, including individually or by playlist. For example, the user may interact with a user interface at gaming device 104 to directly select the shared game state from shared game states 122 (in the form of shared saved game data 128). In another example, the user may interact with a user interface at gaming device 104 to select the shared game state from a playlist in game playlists 120, such as playlist 406 of FIG. 4 (e.g., the user could select the saved game state identified by saved game state identifier 410A). In still another example, the user may interact with a user interface at gaming device 104 to select a playlist from a list of available playlists, such as by selecting playlist identifier 408 (for playlist 406) from playlist list 502 in FIG. 5. The selected playlist may include one or more shared game states that the user desires to try.

These selection techniques are further described herein. For instance, FIG. 6 shows a flowchart 600 of a process for selecting a shared video game state for gameplay from a selected playlist, according to an embodiment. Flowchart 600 may be performed by playlist manager 208 of FIG. 2. Other structural and operational embodiments will be apparent to persons skilled in the relevant art(s) based on the following discussion regarding flowchart 600.

Flowchart 600 begins with step 602. In step 602, selection is received from the user of a saved game playlist identifying a plurality of games states of one or more video games. In an embodiment, playlist manager 208 of game play management system 110 at server 102 and playlist handler 216 of shared game state execution handler 116 may enable a saved game playlist to be selected. In particular, a user at gaming device 104 may use user input device 202 to interact with a user interface provided by playlist handler 216 (e.g., displayed at display screen 106) to navigate to a playlist list screen. This may cause playlist handler 216 to generate a playlist list request 222 transmitted (e.g., over network 108 of FIG. 1) to playlist manager 208. In response, playlist manager 208 may transmit a list of playlists 224 to playlist handler 216, such as playlist list 502 of FIG. 5, that may be displayed and interacted with by a user to select a playlist. For example, as shown in FIG. 5, user interface 404 may be displayed to the user with playlist lists 502 and fifth control 508 (labeled “Play”) shown. The user may be able to highlight a desired playlist of playlists list 502 in any manner by interaction with user input device 202 (e.g., mouse click, controller knob, trigger button, touch, etc.), and then select fifth control 508 to initiate play of the selected playlist. As shown in FIG. 2, user input 240, indicating a selected playlist, is received by playlist handler 216. Playlist handler 216 may transmit playlist request 226, which indicates the selected playlist, to playlist manager 208.

In step 604, the saved game playlist is downloaded from the saved game repository. In an embodiment, in response to playlist request 226, playlist manager 208 may access the indicated selected playlist from game playlists 120, and transmit the playlist to playlist handler 216 as selected playlist 228.

In step 606, a selection of the first game state from the saved game playlist is received. In an embodiment, playlist handler 216 may display the selected playlist (e.g., in a UI in display screen 106), listing all of the saved game states included within. The user may provide user input 240 as an indication of the selected saved game state for game play. For instance, user interface 404 of FIG. 4 may be presented to the user with playlist 406 and third control 416 shown. The user may interact with user interface 404 using user input device 202 to highlight a particular shared saved game identified in playlist 406, and may select third control 416 to initiate play of the selected shared saved game. Playlist handler 216 provides a selected saved game state 230 to game state downloader 212, indicating the saved game state selected by the user. Game state downloader 212 transmits a game state download request 232 to game state manager 206 (e.g., over network 108 of FIG. 1), indicating the saved game state selected by the user.

In step 608, the saved game data is downloaded in response to the received selection. In an embodiment, in response to game state download request 232, game state manager 206 may access the indicated selected saved game state from shared game states 122, and transmit the accessed game state (in the form of shared saved game data 128) to game state downloader 212 as selected game state 234.

Note that the user may select further saved game states from the same or different playlists in a similar manner. Furthermore, although flowchart 600 describes the user selecting a game state from a selected playlist for game play, in another embodiment, once a playlist is selected by the user, playlist handler 216 may automatically instruct game state downloader 212 to download the first game state listed therein, followed by downloading the next listed game state, etc. As each downloaded game state is loaded and played through by the user at gaming device 104, the next listed game state may be loaded and played through, until all game states of the playlist are played through.

C. Embodiments for Enabling Play of Saved Game States Individually and from Playlists at Gaming Devices

As described above, game states may be individually selected and downloaded for play, or a playlist may be selected so that the game states listed therein may be played through in sequence at a gaming device. In embodiments, game play client platform 114 at gaming device 104 and game play management system 110 at server 102 may enable game play using such games states in various ways.

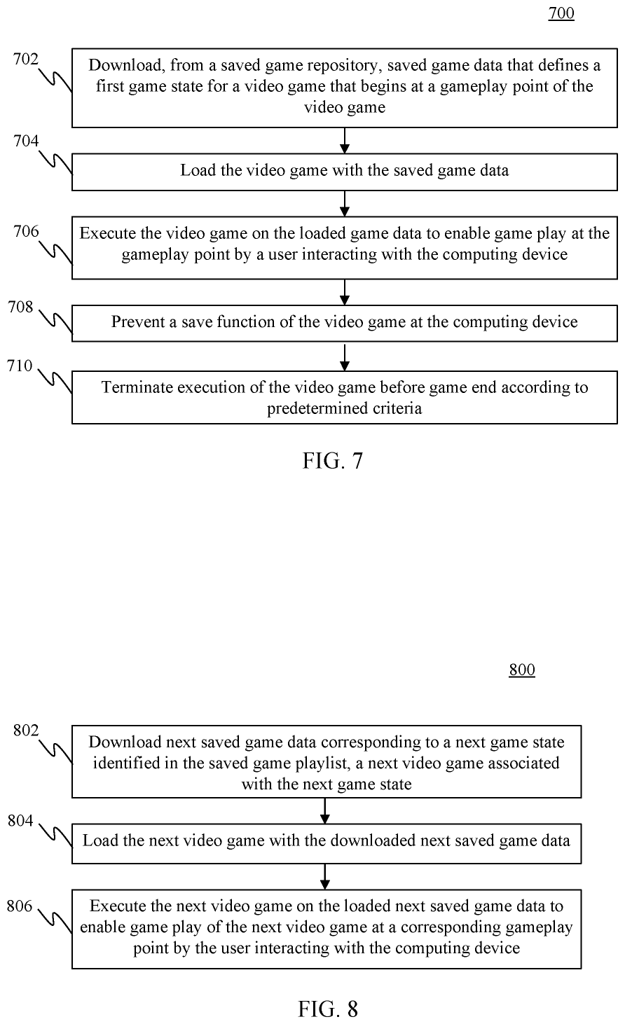

For instance, FIG. 7 shows a flowchart 700 of a process in a user device for playing shared saved video game states, according to an embodiment. Flowchart 700 may be performed by game play client platform 114 of FIG. 2. Other structural and operational embodiments will be apparent to persons skilled in the relevant art(s) based on the following discussion regarding flowchart 700.

Flowchart 700 begins with step 702. In step 702, saved game data is downloaded from a saved game repository, the saved game data defining a first game state for a video game that begins at a gameplay point of the video game. As described above with respect to FIG. 6, game state manager 206 may access a selected saved game state from shared game states 122, and transmit the selected game state (in the form of shared saved game data 128) to game state downloader 212 as selected game state 234.

In step 704, the video game is loaded with the saved game data. As shown in FIG. 2, game engine 214 may load video game application 132. Furthermore, game state downloader 212 may provide selected game state 234 to game engine 214. Game engine 214 is configured to execute video game applications on behalf of game play client platform 114. For example, game engine 214 may include a rendering engine that generates two-dimensional or three-dimensional graphics (e.g., by rasterization, ray-tracing, etc.) of video game application 132, an audio engine for the loading, modifying, and output of audio/sound of video game application 132, a physics engine, and/or other components that enable the execution of video games. Game engine 214 loads video game application 132 with selected game state 234. In this manner game engine 214 may execute video game application 132 to begin play from the gameplay point defined by the game state data of selected game state 234.

In step 706, the video game is executed on the loaded game data to enable game play at the gameplay point by a user interacting with the computing device. Game engine 214 is configured to execute video game application 132 to begin play from the gameplay point defined by the game state data of selected game state 234. Based thereon, game engine 214 generates video game video 116 displayed at display screen 106, sound that is played from one or more speakers (e.g., loudspeakers, headphones, etc.), and optionally vibrational or other output to user input device 202. In this manner, the user of gaming device 104 is enabled to play through the gameplay moment/segment that the contributing user of the game state data desired to share.

In step 708, a save function of the video game is prevented at the computing device. In an embodiment, game function inhibiter 220 is configured to inhibit one or more functions of video game application 132 while a shared saved game state is being played. For instance, a save function of video game application 132 may be prevented at gaming device 104 to disable saving in-game progress proceeding from the loaded game state. This is because the user may not have purchased video game application 132, and thus may only have license to play through a saved game state (if such play is allowed by video game application 132 by its developer/distributor), not to save the game state and potentially play it in an unlimited fashion. Furthermore, this may help preserve fairness in the game ecosystem, as noted further above.

In further embodiments, game function inhibiter 220 may inhibit further functions of video game application 132, including the accumulation of in-game achievements, high-scores for leaderboards, accumulating points toward the user's gamer score, etc., to preserve ecosystem fairness and/or for other reasons. Further examples of functions of video game application 132 that game function inhibiter 220 may inhibit include: earning rewards when video game application 132 and/or gaming system 200 enable rewarding users for accomplishments; sharing accomplishments of the user on an activity feed or otherwise; and/or recording screen shots or videos by the user for personal or shared use.

Note that step 708 is optional, and in some cases, the user may be allowed to save in-game progress after beginning play of video game application 132 from a shared game state, for later game play. Furthermore, in an embodiment, game function inhibiter 220 alternatively (or a second instance thereof) may be located at server 102 in shared game state serving system 112. For example, as shown in FIG. 2, game play statistics manager 210 may be present at server 102. In an embodiment, game play statistics manager 210 may be configured to inhibit the one or more functions of video game application 132 while a shared saved game state is being played, including preventing the save function of video game application 132. Game play statistics manager 210 is described in greater detail further below.

In step 710, execution of the video game is terminated before game end according to predetermined criteria. In an embodiment, game execution terminator 218 is configured to terminate execution of video game application 132 by game engine 214 before an ending of game play of video game application 132. In particular, game execution terminator 218 is configured to terminate execution of video game application 132 according to predetermined criteria by providing a terminate instruction 236 to game engine 214. Playlist handler 216 may also receive terminate instruction 236 as a signal to have game state downloader 212 download and/or supply a next game state of an active playlist to game engine 214 for play.

Such controlled termination of video game application 132 by game execution terminator 218 prevents unconstrained play of the video game that might be otherwise possible by loading the saved game state. For example, game execution terminator 218 prevents unconstrained play if the user has not purchased, or does not otherwise have unfettered access (e.g., via a game subscription), to video game application 132.

For instance, in one embodiment, game execution terminator 218 may be configured to detect passage of a predetermined amount of time during the game play, such as 1 minute, 5 minutes, etc. This allows the user enough time to play through the gameplay moment of interest. Once the time is detected to have passed, game execution terminator 218 may terminate execution of the video game. In another embodiment, game execution terminator 218 may be configured to terminate execution of the video game after the user has attempted the shared saved game a predetermined number of times. In still another embodiment, game execution terminator 218 may be configured to detect a predetermined in-game event during gameplay of the saved game state. In response to detecting the predetermined in-game event, game execution terminator 218 terminates execution of the video game. In this manner, game execution terminator 218 may detect the actual gameplay moment of interest, and then terminate.

A detectable in-game event may be programmed into video game application 132, may be machine learned, or may be otherwise configured. Examples of in-game events that may trigger termination by game execution terminator 218 include: collecting a predetermined number of items; using a predetermined amount of items; triggering a particular character status (e.g., of a character, a game level, etc.); defeating a particular enemy; and/or finishing a specific game stage.

Game execution terminator 218 may be configured in various ways to detect a predetermined in-game event. For example, in an embodiment, machine learning (ML) may be used to detect particular visuals in video game video 116 and/or particular sounds in video game application 132 that signal the event of interest has occurred. In such an embodiment, game execution terminator 218 may include a ML model trained to detect visuals in video game video 116. The ML model may be generated/trained in any suitable manner, including by supervised ML model generation algorithms such as supervised vector machines (SVM), linear regression, logistic regression, naïve Bayes, linear discriminant analysis, decision trees, k-nearest neighbor algorithm, neural networks, etc. In an embodiment, the ML model may provide a confidence level indicative of whether a feature is identified in game data. If the confidence level is sufficient (e.g., over 50%), the feature may be indicated as detected, and game play may thereafter be terminated.

For instance, the ML model may be a trained model for a car-related video game, and thus may be trained to be capable of determining that a car jump has occurred, a car crash has occurred, etc. (e.g., by identifying vehicle rotation, explosions, etc.). The machine learning algorithm may receive many various training indications associated with identifying a car attributes and/or explosions to use to learn how to recognize unusual car-related events during video game play.

The ML model may be generated in various forms, including an algorithm, a decision tree, etc. In the case of a decision tree, the tree may be traversed with input data (video data, audio data, input events, machine usage data, etc.) to identify a feature. In another example, the ML model may be generated by artificial neural network learning algorithm as a neural network that is an interconnected group of artificial neurons.

As mentioned above, once game play of a downloaded game state is ended, a next game state of a playlist may be played. For instance, FIG. 8 shows a flowchart 800 of a process for playing a video game on game states of a playlist, according to an embodiment. Flowchart 800 may be an extension of flowchart 700. Flowchart 800 may be performed by game play client platform 114 of FIG. 2. Other structural and operational embodiments will be apparent to persons skilled in the relevant art(s) based on the following discussion regarding flowchart 800.

Flowchart 800 begins with step 802. In step 802, a next saved game data is downloaded corresponding to a next game state identified in the saved game playlist, a next video game associated with the next game state. As described above, playlist handler 216 may instruct game state downloader 212 to download a next game state of a playlist. Game state downloader 212 may transmit game state download request 232 to game state manager 206, indicating a next game state of the active playlist for download. In response, game state manager 206 may access and transmit the next saved game state to game state downloader 212 as selected game state 234.

In step 804, the next video game is loaded with the downloaded next saved game data. As shown in FIG. 2, game engine 214 loads video game application 132 with the selected game state 234. Game engine 214 may already have video game application 132 loaded (e.g., in memory) or may load a different video game application if selected game state 234 pertains to a different video game than the prior game state of the playlist.

In step 806, the next video game is executed on the loaded next saved game data to enable game play of the next video game at a corresponding gameplay point by the user interacting with the computing device. As described above, game engine 214 is configured to execute video game application 132 to begin play from the gameplay point defined by the game state data of selected game state 234. In this manner, the user of gaming device 104 is enabled to play through the gameplay moment/segment of the next game state of the playlist. Note that flowchart 800 may be repeated for each game state of the playlist, with steps 708 and 710 also being performed subsequent to step 806 of flowchart 800 in each case.

Furthermore, note that in an offline context, where gaming device 104 is not connected to a network during game play, one or more of the playlists of game playlists 120, and any game states thereof in shared game states 122, may have been previously downloaded to local storage of gaming device 104. A playlist for play may be selected by the user from local storage (in a similar manner as described above for selection from storage 130) by playlist handler 216, and the game states of the selected playlist may be sequentially loaded from the local storage by game state downloader 212, to be loaded by game engine 214 into video game application 132 for offline game play.

D. Embodiments for Serving Shared Saved Game States for Gameplay

The prior subsection described the sharing of saved game states largely (though not entirely) from the gaming device perspective. This subsection describes the sharing of saved games states mainly from the server perspective.

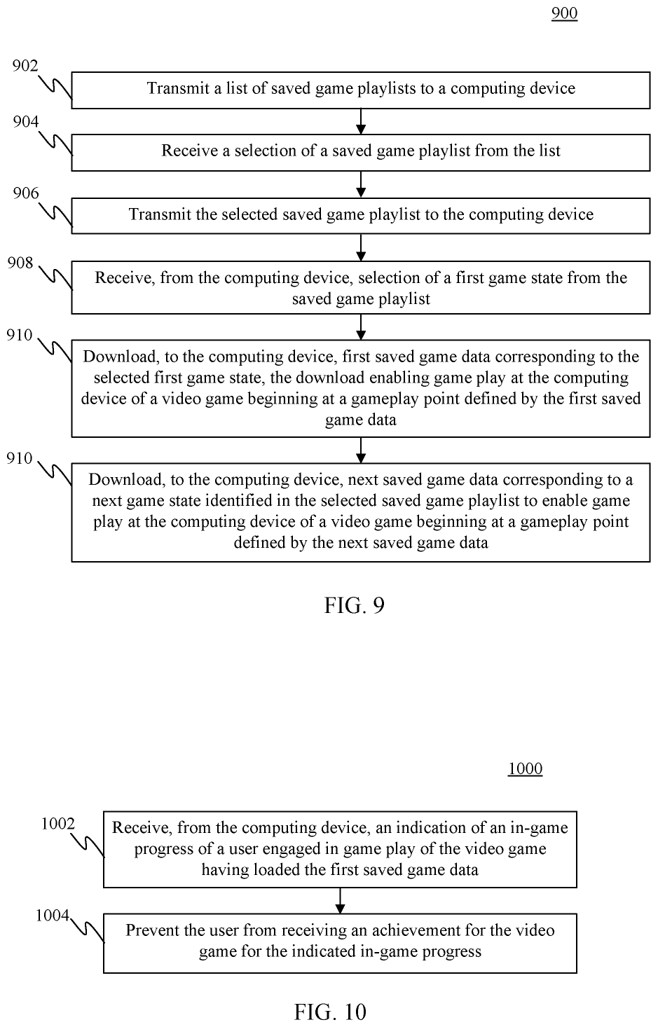

In particular, FIG. 9 shows a flowchart 900 of a process in a server for enabling play of shared saved video game states at a user device, according to an example embodiment. Flowchart 900 may be performed by shared game state serving system 112 in server 102 of FIG. 2. Other structural and operational embodiments will be apparent to persons skilled in the relevant art(s) based on the following discussion regarding flowchart 900.

Flowchart 900 begins with step 902. In step 902, a list of saved game playlists is transmitted to a computing device. As described above, playlist manager 208 may transmit a list of playlists 224 to playlist handler 216, such as playlist list 502 of FIG. 5.

In step 904, a selection of a saved game playlist from the list is received. As described above, the list of playlists may be displayed and interacted with by a user to select a playlist. For instance, as shown in FIG. 2, the user may provide user input 240 to playlist handler 216 indicating a selected playlist. Playlist handler 216 may transmit playlist request 226, which indicates the selected playlist. Playlist manager 208 receives playlist request 226.

In step 906, the selected saved game playlist is transmitted to the computing device. In an embodiment, in response to playlist request 226, playlist manager 208 may access the indicated selected playlist from game playlists 120, and transmit the playlist to playlist handler 216 as selected playlist 228.

In step 908, selection of a first game state from the saved game playlist is received from the computing device. As described above, playlist handler 216 may display the selected playlist to the user. The user may provide user input 240 as an indication of a selected saved game state from the selected playlist. Alternatively, playlist handler 216 automatically selects the first saved game state in the playlist to be the first to be downloaded. Playlist handler 216 provides a selected saved game state 230 to game state downloader 212, indicating the selected saved game state. Game state downloader 212 transmits a game state download request 232 indicating the saved game state selected by the user. Game state manager 206 receives game state download request 232.

In step 910, first saved game data corresponding to the selected first game state is downloaded to the computing device, the download enabling game play at the computing device of a video game beginning at a gameplay point defined by the first saved game data. As described above, game state manager 206 may access the selected saved game state from shared game states 122, and transmit the selected game state to game state downloader 212 as selected game state 234. The user is thereby enabled to play the video game beginning at the gameplay point defined by selected game state 234 until gameplay is terminated (e.g., as described above).

In step 912, next saved game data corresponding to a next game state identified in the selected saved game playlist is downloaded to the computing device to enable game play at the computing device of a video game beginning at a gameplay point defined by the next saved game data. Upon termination of game play of the game state downloaded in step 910, game state manager 206 may access the next saved game state of the playlist from shared game states 122, either as instructed by playlist handler 216 (at termination of the prior game state) or automatically, and may transmit the selected game state to game state downloader 212 as selected game state 234. The user is thereby enabled to play the video game beginning at the gameplay point defined by the next game state in the playlist until gameplay is terminated (e.g., as described above). At this point, a next game state in the playlist may be downloaded for play, and this process may continue until the user decides to stop playing or all game states of the playlist have been downloaded and played.

Note that in an embodiment, a user interface generated by playlist handler 216 may enable a user to skip downloading and/or playing some of the game states of the playlist, as indicated by the user. Furthermore, note that playlist handler 216 may show descriptions and/or previews of each next game state to the user, to aid the user in deciding whether or not to skip the game states. Still further, playlist handler 216 may show advertisements to the user while a game state is being downloaded, may provide an purchase link or other interface to enable the user to purchase a video game while a game state is being downloaded, or may otherwise entertain a user during game state download.

FIG. 10 shows a flowchart 1000 of a process in a server for suppressing game functions of a video game playing at a user device from a shared saved video game state, according to an example embodiment. Flowchart 1000 may be performed by game play statistics manager 210 of FIG. 2. Other structural and operational embodiments will be apparent to persons skilled in the relevant art(s) based on the following discussion regarding flowchart 1000.

Flowchart 1000 begins with step 1002. In step 1002, an indication is received from the computing device of an in-game progress of a user engaged in game play of the video game having loaded the first saved game data. Game engine 214 may generate in-game progress information 238 regarding play of video game application 132 by a user that is transmitted to game play statistics manager 210 at server 102. In-game progress information 238 may include a game score, a game achievement, a game milestone, and/or other in-game progress indication that may be generated by video game application 132 during normal game play by the user.

In step 1004, the user is prevented from receiving an achievement for the video game for the indicated in-game progress. In an embodiment, game play statistics manager 210 is configured to prevent the user from receiving achievements, high scores for leaderboards, points toward the user's gamer score, and/or other in-game milestones during play of shared saved game states, as well as suppressing game saves during play of shared saved game states. The reason for this is to enable game sharing without adversely affecting the health or fairness of the overall ecosystem. This is because users that receive and play from shared game states may obtain achievements or game scores they could not achieve on their own, or achieve as soon as a shared game state enables. As such, game play statistics manager 210 suppresses such milestones received during play of shared game states. Any number and type of game functions may be suppressed by game play statistics manager 210, in any combination.

Note that in another embodiment, game play statistics manager 210 may not suppress milestones received during play of shared game states. Alternatively, game play statistics manager 210 may suppress milestones received during play of shared game states from public forums (e.g., the user's public gamer score, public leaderboards, etc.), and instead may log those milestones to a secondary tier forum for such milestones (e.g., a non-public gamer score for the user, non-public leaderboards, etc.). Furthermore, as described above, game function inhibiter 220 (FIG. 2) may be present to perform the suppressing of game functions. In such case, game play statistics manager 210 may not need to be present. Alternatively, game play statistics manager 210 and game function inhibiter 220 may each be configured to perform suppression for a corresponding subset of game functions.

### III. Example Computer System Implementation

Server 102, gaming device 104, game play management system 100, shared game state serving system 112, game play client platform 114, shared game state execution handler 116, playlist creator 204, game state manager 206, playlist manager 208, game play statistics manager 210, game state downloader 212, game engine 214, playlist handler 216, game execution terminator 218, game function inhibiter 220, flowchart 300, flowchart 600, flowchart 700, flowchart 800, flowchart 900, and flowchart 1000 may be implemented in hardware, or hardware combined with one or both of software and/or firmware. For example, game play management system 110, shared game state serving system 112, game play client platform 114, shared game state execution handler 116, playlist creator 204, game state manager 206, playlist manager 208, game play statistics manager 210, game state downloader 212, game engine 214, playlist handler 216, game execution terminator 218, game function inhibiter 220, flowchart 300, flowchart 600, flowchart 700, flowchart 800, flowchart 900, and/or flowchart 1000 may be implemented as computer program code/instructions configured to be executed in one or more processors and stored in a computer readable storage medium. Alternatively, game play management system 110, shared game state serving system 112, game play client platform 114, shared game state execution handler 116, playlist creator 204, game state manager 206, playlist manager 208, game play statistics manager 210, game state downloader 212, game engine 214, playlist handler 216, game execution terminator 218, game function inhibiter 220, flowchart 300, flowchart 600, flowchart 700, flowchart 800, flowchart 900, and/or flowchart 1000 may be implemented as hardware logic/electrical circuitry.

For instance, in an embodiment, one or more, in any combination, of game play management system 110, shared game state serving system 112, game play client platform 114, shared game state execution handler 116, playlist creator 204, game state manager 206, playlist manager 208, game play statistics manager 210, game state downloader 212, game engine 214, playlist handler 216, game execution terminator 218, game function inhibiter 220, flowchart 300, flowchart 600, flowchart 700, flowchart 800, flowchart 900, and/or flowchart 1000 may be implemented together in a SoC. The SoC may include an integrated circuit chip that includes one or more of a processor (e.g., a central processing unit (CPU), microcontroller, microprocessor, digital signal processor (DSP), etc.), memory, one or more communication interfaces, and/or further circuits, and may optionally execute received program code and/or include embedded firmware to perform functions.

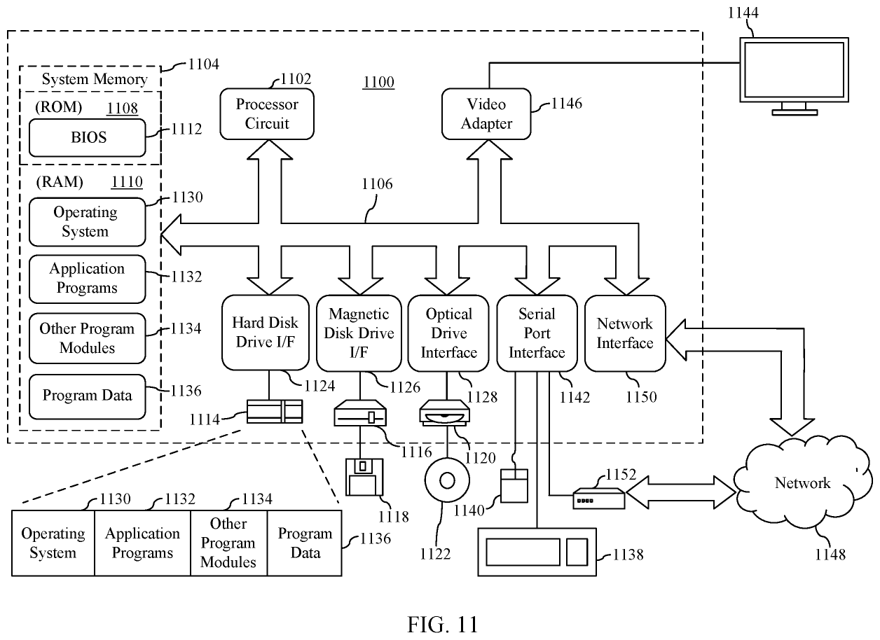

FIG. 11 depicts an exemplary implementation of a computing device 1100 in which embodiments may be implemented. For example, server 102 and gaming device 104 may each be implemented in one or more computing devices similar to computing device 1100 in stationary or mobile computer embodiments, including one or more features of computing device 1100 and/or alternative features. The description of computing device 1100 provided herein is provided for purposes of illustration, and is not intended to be limiting. Embodiments may be implemented in further types of computer systems, as would be known to persons skilled in the relevant art(s).

As shown in FIG. 11, computing device 1100 includes one or more processors, referred to as processor circuit 1102, a system memory 1104, and a bus 1106 that couples various system components including system memory 1104 to processor circuit 1102. Processor circuit 1102 is an electrical and/or optical circuit implemented in one or more physical hardware electrical circuit device elements and/or integrated circuit devices (semiconductor material chips or dies) as a central processing unit (CPU), a microcontroller, a microprocessor, and/or other physical hardware processor circuit. Processor circuit 1102 may execute program code stored in a computer readable medium, such as program code of operating system 1130, application programs 1132, other programs 1134, etc. Bus 1106 represents one or more of any of several types of bus structures, including a memory bus or memory controller, a peripheral bus, an accelerated graphics port, and a processor or local bus using any of a variety of bus architectures. System memory 1104 includes read only memory (ROM) 1108 and random-access memory (RAM) 1110. A basic input/output system 1112 (BIOS) is stored in ROM 1108.

Computing device 1100 also has one or more of the following drives: a hard disk drive 1114 for reading from and writing to a hard disk, a magnetic disk drive 1116 for reading from or writing to a removable magnetic disk 1118, and an optical disk drive 1120 for reading from or writing to a removable optical disk 1122 such as a CD ROM, DVD ROM, or other optical media. Hard disk drive 1114, magnetic disk drive 1116, and optical disk drive 1120 are connected to bus 1106 by a hard disk drive interface 1124, a magnetic disk drive interface 1126, and an optical drive interface 1128, respectively. The drives and their associated computer-readable media provide nonvolatile storage of computer-readable instructions, data structures, program modules and other data for the computer. Although a hard disk, a removable magnetic disk and a removable optical disk are described, other types of hardware-based computer-readable storage media can be used to store data, such as flash memory cards, digital video disks, RAMs, ROMs, and other hardware storage media.

A number of program modules may be stored on the hard disk, magnetic disk, optical disk, ROM, or RAM. These programs include operating system 1130, one or more application programs 1132, other programs 1134, and program data 1136. Application programs 1132 or other programs 1134 may include, for example, computer program logic (e.g., computer program code or instructions) for implementing computing device 102, gaming device 104, game play management system 110, shared game state serving system 112, game play client platform 114, shared game state execution handler 116, playlist creator 204, game state manager 206, playlist manager 208, game play statistics manager 210, game state downloader 212, game engine 214, playlist handler 216, game execution terminator 218, game function inhibiter 220, flowchart 300, flowchart 600, flowchart 700, flowchart 800, flowchart 900, flowchart 1000, flowchart 1100, and/or further embodiments described herein.

A user may enter commands and information into computing device 1100 through input devices such as keyboard 1138 and pointing device 1140. Other input devices (not shown) may include a microphone, joystick, game pad, satellite dish, scanner, a touch screen and/or touch pad, a voice recognition system to receive voice input, a gesture recognition system to receive gesture input, or the like. These and other input devices are often connected to processor circuit 1102 through a serial port interface 1142 that is coupled to bus 1106, but may be connected by other interfaces, such as a parallel port, game port, or a universal serial bus (USB).

A display screen 1144 is also connected to bus 1106 via an interface, such as a video adapter 1146. Display screen 1144 may be external to, or incorporated in computing device 1100. Display screen 1144 may display information, as well as being a user interface for receiving user commands and/or other information (e.g., by touch, finger gestures, virtual keyboard, etc.). In addition to display screen 1144, computing device 1100 may include other peripheral output devices (not shown) such as speakers and printers.

Computing device 1100 is connected to a network 1148 (e.g., the Internet) through an adaptor or network interface 1150, a modem 1152, or other means for establishing communications over the network. Modem 1152, which may be internal or external, may be connected to bus 1106 via serial port interface 1142, as shown in FIG. 11, or may be connected to bus 1106 using another interface type, including a parallel interface.

As used herein, the terms “computer program medium,” “computer-readable medium,” and “computer-readable storage medium” are used to refer to physical hardware media such as the hard disk associated with hard disk drive 1114, removable magnetic disk 1118, removable optical disk 1122, other physical hardware media such as RAMs, ROMs, flash memory cards, digital video disks, zip disks, MEMs, nanotechnology-based storage devices, and further types of physical/tangible hardware storage media. Such computer-readable storage media are distinguished from and non-overlapping with communication media (do not include communication media). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Embodiments are also directed to such communication media that are separate and non-overlapping with embodiments directed to computer-readable storage media.

As noted above, computer programs and modules (including application programs 1132 and other programs 1134) may be stored on the hard disk, magnetic disk, optical disk, ROM, RAM, or other hardware storage medium. Such computer programs may also be received via network interface 1150, serial port interface 1142, or any other interface type. Such computer programs, when executed or loaded by an application, enable computing device 1100 to implement features of embodiments discussed herein. Accordingly, such computer programs represent controllers of the computing device 1100.

Embodiments are also directed to computer program products comprising computer code or instructions stored on any computer-readable medium. Such computer program products include hard disk drives, optical disk drives, memory device packages, portable memory sticks, memory cards, and other types of physical storage hardware.

### IV. Additional Example Embodiments

In a first embodiment, a system in a computing device comprises: a game state downloader configured to download, from a saved game repository, saved game data that defines a first game state for a video game that begins at a gameplay point of the video game; a game engine configured to load the video game with the saved game data, and execute the video game on the loaded game data to enable game play at the gameplay point by a user interacting with the computing device; and a game execution terminator configured to terminate execution of the video game before game end according to predetermined criteria.

In an embodiment, the system further comprises: a playlist handler configured to receive selection by the user of a saved game playlist identifying a plurality of games states of one or more video games, download the saved game playlist from the saved game repository, and receive a selection of the first game state from the saved game playlist; and the game state downloader is configured to download the saved game data in response to the received selection of the first game state at the playlist handler.

In an embodiment, the game state downloader is configured to: subsequent to terminating execution of the video game download next saved game data corresponding to a next game state identified in the saved game playlist, a next video game associated with the next game state; and the game engine is configured to load the next video game with the downloaded next saved game data; and execute the next video game on the loaded next saved game data to enable game play of the next video game at a corresponding gameplay point by the user interacting with the computing device.

In an embodiment, the system further comprises: a game function inhibiter configured to prevent a function of the video game at the computing device while executing the video game on the loaded game data, the function including at least one of: a save function, an accumulation of in-game achievements by the user, recording a high-score by the user for a leaderboard, an accumulation of points toward a gamer score of the user, earning of rewards for accomplishments by the user, sharing of accomplishments of the user, or recording screen shots or videos by the user.

In an embodiment, the game execution terminator is configured to: detect at least one of passage of a predetermined amount of time during the game play, or a predetermined number of attempts at the video game during the game play; and terminate execution of the video game in response to the detected at least one of the passage of the predetermined amount of time or the predetermined number of attempts at the video game.

In an embodiment, the game execution terminator is configured to: detect a predetermined in-game event during said game play, the predetermined in-game event including at least one of collecting a predetermined number of items, using a predetermined amount of items, triggering a particular character status, defeating a particular enemy, or finishing a specific game stage; and terminate execution of the video game in response to the detection of the predetermined in-game event.

In another embodiment, a method in a computing device comprises: downloading, from a saved game repository, saved game data that defines a first game state for a video game that begins at a gameplay point of the video game; loading the video game with the saved game data; executing the video game on the loaded game data to enable game play at the gameplay point by a user interacting with the computing device; and terminating execution of the video game before game end according to predetermined criteria.

In an embodiment, the method further comprises: receiving selection by the user of a saved game playlist identifying a plurality of games states of one or more video games; downloading the saved game playlist from the saved game repository; receiving a selection of the first game state from the saved game playlist; and wherein said downloading the saved game data comprises: downloading the saved game data in response to the received selection.

In an embodiment, the method further comprises: subsequent to said terminating, downloading next saved game data corresponding to a next game state identified in the saved game playlist, a next video game associated with the next game state; loading the next video game with the downloaded next saved game data; and executing the next video game on the loaded next saved game data to enable game play of the next video game at a corresponding gameplay point by the user interacting with the computing device.

In an embodiment, the method further comprises: preventing a function of the video game at the computing device while executing the video game on the loaded game data, the function including at least one of: a save function, an accumulation of in-game achievements by the user, recording a high-score by the user for a leaderboard, an accumulation of points toward a gamer score of the user, earning of rewards for accomplishments by the user, sharing of accomplishments of the user, or recording screen shots or videos by the user.

In an embodiment, said terminating comprises: detecting at least one of passage of a predetermined amount of time during the game play, or a predetermined number of attempts at the video game during the game play; and terminating execution of the video game in response to said detecting.

In an embodiment, said terminating comprises: detecting a predetermined in-game event during said game play, the predetermined in-game event including at least one of collecting a predetermined number of items, using a predetermined amount of items, triggering a particular character status, defeating a particular enemy, or finishing a specific game stage; and terminating execution of the video game in response to said detecting.

In still another embodiment, a system in a server comprises: a playlist manager configured to transmit a list of saved game playlists to a computing device, receive a selection of a saved game playlist from the list, and transmit the selected saved game playlist to the computing device; and a game state manager configured to receive a selection of a first game state from the saved game playlist, and download, to the computing device, first saved game data corresponding to the selected first game state to enable game play at the computing device of a video game beginning at a gameplay point defined by the first saved game data.

In an embodiment, the game state manager is further configured to: download, to the computing device, next saved game data corresponding to a next game state identified in the selected saved game playlist to enable game play at the computing device of a video game beginning at a gameplay point defined by the next saved game data.

In an embodiment, the system further comprises: a game play statistics manager configured to receive, from the computing device, an indication of an in-game progress of a user engaged in game play of the video game having loaded the first saved game data; and suppress the in-game progress indication.

In an embodiment, the game play statistics manager is configured to perform at least one of: prevent the user from being indicated on a leaderboard for the video game for the indicated in-game progress; or prevent the user from receiving an achievement for the video game for the indicated in-game progress.

In still another embodiment, a method in a server comprises: transmitting a list of saved game playlists to a computing device; receiving a selection of a saved game playlist from the list; transmitting the selected saved game playlist to the computing device; receiving, from the computing device, selection of a first game state from the saved game playlist; and downloading, to the computing device, first saved game data corresponding to the selected first game state, said downloading enabling game play at the computing device of a video game beginning at a gameplay point defined by the first saved game data.

In an embodiment, the method further comprises: downloading, to the computing device, next saved game data corresponding to a next game state identified in the selected saved game playlist to enable game play at the computing device of a video game beginning at a gameplay point defined by the next saved game data.

In an embodiment, the method further comprises: receiving, from the computing device, an indication of an in-game progress of a user engaged in game play of the video game having loaded the first saved game data; and suppressing the in-game progress indication.

In an embodiment, said suppressing comprises at least one of: preventing the user from being indicated on a leaderboard for the video game for the indicated in-game progress; or preventing the user from receiving an achievement for the video game for the indicated in-game progress.

### V. Conclusion

While various embodiments of the present application have been described above, it should be understood that they have been presented by way of example only, and not limitation. It will be understood by those skilled in the relevant art(s) that various changes in form and details may be made therein without departing from the spirit and scope of the application as defined in the appended claims. Accordingly, the breadth and scope of the present application should not be limited by any of the above-described exemplary embodiments, but should be defined only in accordance with the following claims and their equivalents.

What is claimed is:

1. A system in a computing device, comprising:
a game state downloader configured to download, from a saved game repository, saved game data that defines a first game state for a video game that begins at a gameplay point of the video game;
a game engine configured to
load the video game with the saved game data, and
execute the video game on the loaded game data to enable game play at the gameplay point by a user interacting with the computing device; and
a game execution terminator configured to terminate execution of the video game before game end according to predetermined criteria.

2. The system of claim 1, further comprising:
a playlist handler configured to
receive selection by the user of a saved game playlist identifying a plurality of games states of one or more video games,
download the saved game playlist from the saved game repository, and
receive a selection of the first game state from the saved game playlist; and
the game state downloader is configured to download the saved game data in response to the received selection of the first game state at the playlist handler.

3. The system of claim 2, wherein the game state downloader is configured to:
subsequent to terminating execution of the video game
download next saved game data corresponding to a next game state identified in the saved game playlist, a next video game associated with the next game state; and
the game engine is configured to
load the next video game with the downloaded next saved game data; and
execute the next video game on the loaded next saved game data to enable game play of the next video game at a corresponding gameplay point by the user interacting with the computing device.

4. The system of claim 1, further comprising:
a game function inhibiter configured to prevent a function of the video game at the computing device while executing the video game on the loaded game data, the function including at least one of:
a save function,
an accumulation of in-game achievements by the user,
recording a high-score by the user for a leaderboard,
an accumulation of points toward a gamer score of the user,
earning of rewards for accomplishments by the user,
sharing of accomplishments of the user, or
recording screen shots or videos by the user.

5. The system of claim 1, wherein the game execution terminator is configured to:
detect at least one of
passage of a predetermined amount of time during the game play, or
a predetermined number of attempts at the video game during the game play; and
terminate execution of the video game in response to the detected at least one of the passage of the predetermined amount of time or the predetermined number of attempts at the video game.

6. The system of claim 1, wherein the game execution terminator is configured to:
detect a predetermined in-game event during said game play, the predetermined in-game event including at least one of
collecting a predetermined number of items,
using a predetermined amount of items,
triggering a particular character status,
defeating a particular enemy, or
finishing a specific game stage; and
the game execution terminator is configured to:
terminate execution of the video game in response to the detection of the predetermined in-game event.

7. A method in a computing device, comprising:
downloading, from a saved game repository, saved game data that defines a first game state for a video game that begins at a gameplay point of the video game;
loading the video game with the saved game data;
executing the video game on the loaded game data to enable game play at the gameplay point by a user interacting with the computing device; and
terminating execution of the video game before game end according to predetermined criteria.

8. The method of claim 7, further comprising:
receiving selection by the user of a saved game playlist identifying a plurality of games states of one or more video games;
downloading the saved game playlist from the saved game repository;
receiving a selection of the first game state from the saved game playlist; and
wherein said downloading the saved game data comprises:
downloading the saved game data in response to the received selection.

9. The method of claim 8, further comprising:
subsequent to said terminating, downloading next saved game data corresponding to a next game state identified in the saved game playlist, a next video game associated with the next game state;
loading the next video game with the downloaded next saved game data; and
executing the next video game on the loaded next saved game data to enable game play of the next video game at a corresponding gameplay point by the user interacting with the computing device.

10. The method of claim 1, further comprising:
preventing a function of the video game at the computing device while executing the video game on the loaded game data, the function including at least one of:
a save function,
an accumulation of in-game achievements by the user,
recording a high-score by the user for a leaderboard,
an accumulation of points toward a gamer score of the user,
earning of rewards for accomplishments by the user,
sharing of accomplishments of the user, or
recording screen shots or videos by the user.

11. The method of claim 7, wherein said terminating comprises:
detecting at least one of
passage of a predetermined amount of time during the game play, or
a predetermined number of attempts at the video game during the game play; and
terminating execution of the video game in response to said detecting.

12. The method of claim 7, wherein said terminating comprises:
detecting a predetermined in-game event during said game play, the predetermined in-game event including at least one of
collecting a predetermined number of items,
using a predetermined amount of items,
triggering a particular character status,
defeating a particular enemy, or
finishing a specific game stage; and
terminating execution of the video game in response to said detecting.

13. A system in a server, comprising:
a playlist manager configured to
transmit a list of saved game playlists to a computing device,
receive a selection of a saved game playlist from the list, and
transmit the selected saved game playlist to the computing device; and
a game state manager configured to
receive a selection of a first game state from the saved game playlist, and
download, to the computing device, first saved game data corresponding to the selected first game state to enable game play at the computing device of a video game beginning at a gameplay point defined by the first saved game data.

14. The system of claim 13, wherein the game state manager is further configured to:
download, to the computing device, next saved game data corresponding to a next game state identified in the selected saved game playlist to enable game play at the computing device of a video game beginning at a gameplay point defined by the next saved game data.

15. The system of claim 13, further comprising:
a game play statistics manager configured to
receive, from the computing device, an indication of an in-game progress of a user engaged in game play of the video game having loaded the first saved game data; and
suppress the in-game progress indication.

16. The system of claim 15, wherein the game play statistics manager is configured to perform at least one of:
prevent the user from being indicated on a leaderboard for the video game for the indicated in-game progress; or
prevent the user from receiving an achievement for the video game for the indicated in-game progress.

17. A method in a server, comprising:
transmitting a list of saved game playlists to a computing device;
receiving a selection of a saved game playlist from the list;
transmitting the selected saved game playlist to the computing device;
receiving, from the computing device, selection of a first game state from the saved game playlist; and
downloading, to the computing device, first saved game data corresponding to the selected first game state, said downloading enabling game play at the computing device of a video game beginning at a gameplay point defined by the first saved game data.

18. The method of claim 17, further comprising:
downloading, to the computing device, next saved game data corresponding to a next game state identified in the selected saved game playlist to enable game play at the computing device of a video game beginning at a gameplay point defined by the next saved game data.

19. The method of claim 17, further comprising:
receiving, from the computing device, an indication of an in-game progress of a user engaged in game play of the video game having loaded the first saved game data; and
suppressing the in-game progress indication.

20. The method of claim 19, wherein said suppressing comprises at least one of:
preventing the user from being indicated on a leaderboard for the video game for the indicated in-game progress; or
preventing the user from receiving an achievement for the video game for the indicated in-game progress.
